(19) United States
(12) Patent Application Publication
(10) Pub. No.: US 2003/0231610 A1
(43) Pub. Date: Dec. 18, 2003

(54) Providing quality of service within a wireless network

(76) Inventor: Wassim Haddad, Verdun Municipality (CA)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/426,251

(22) Filed: Apr. 30, 2003

(30) Foreign Application Priority Data
Apr. 30, 2002 (GB) 0209969.5

(51) Int. Cl. H04Q 7/24

(52) U.S. Cl. 370/338; 370/229

(57) ABSTRACT

The quality of service of a connection to a wireless network is controlled. Computing devices are connected with at least a high and a low service level to at least one access point of the network. The method causes computing devices connected to the network at the high service level to receive a higher level of service from the network than computing devices connected to the network at the low service level. The higher service level is attained by (1) preferential polling, (2) providing a higher bit rate or lower latency, or the like, for computing devices connected at the higher level of service. The different service levels provide a pricing policy according to the level of service provided.

### FIELD OF THE INVENTION

This invention relates to a wireless network, and a method of providing a wireless network.

### BACKGROUND OF THE INVENTION

Protocols for providing wireless networks include WIFI (or IEEE 802.11) and Bluetooth, which allow a plurality of computing devices to be connected to a base, generally via a radio link. The term connection (as used herein) covers a connection over which data can be sent and is not limited to a physical connection between the computing device and the base station.

To cover an area with a wireless network, the area is provided with sufficient access-points so that a computing device within the area can maintain a connection within the access-point. As a computing device moves through the area covered by the network, the access-point with which it is connected changes; as the signal strength from a first access-point weakens, the signal from a second access-point is likely to become relatively stronger than the signal from the first point, in which case the computing device switches to the second access-point. Therefore, the number of computing devices with which any one access-point is in communication is likely to vary.

In use, an access-point polls each of the computing devices with which it has a connection, and communicates with that computing device for a predetermined time, before breaking the communication and polling the next computing device. Therefore, as the number of computing devices connected to any one access-point increases the percentage of any one time period in which a base station is in communication with the computing device decreases. This decrease in the percentage of time can lead to a reduced network performance. Indeed, the network performance may drop below that required to provide certain functions. It will be appreciated that to provide a real time video link requires more bandwidth than required to send an email message to a computing device that is connected to an access point.

It is an aim of the present invention to provide a solution, or at least reduce, problems associated with prior art wireless networks.

### SUMMARY OF THE INVENTION

According to a first aspect of the invention there is provided a method of controlling the quality of service of a wireless connection to a computing device in at least one wireless local area network having at least a first and a second access point, each arranged to allow the computing device to be connected to a wireless network. The method comprises providing at least a high and a low service level so that computing devices connected to the network at the high service level receive a higher level of service from the network than computing devices connected to the network at the low service level. The first access point is activated to generally provide the high level of service and the second access point is activated to generally provide the low level of service.

An advantage of such an arrangement is that a user of the computing device can decide which level of service is appropriate for his/her needs and cause his/her computing device to be connected to the network at the appropriate service level. Different service levels frequently attract different access charges from the network provider, generally with the higher service levels attracting higher charges. If such a charging scheme is used a user can therefore, decide for itself the appropriate service level to give it a price/performance level with which it is happy.

The method preferably provides a plurality of service levels in between the high level of service and the low level of service. For example the method can provide 1,2,3,4,5,6,7,8,9,10,20,30,50, or any other number of service levels in between the high level of service and the low level of service.

A higher level of service may provide a computing device connected to the at least one access point with a higher bit rate compared to computing devices connected at a lower level of service. For example the high service level may provide a higher bit rate than the low service level. The 802.11a protocol allows data to be transmitted at between 6 Mbps and 54 Mbps. Should the method use the 802.11a protocol, the higher level of service may utilize a bit rate of roughly 54 Mbps, whereas the lower level of service may utilise a bit rate of roughly 6 Mbps. Of course, if the higher bit rates are not obtainable due to poor connections the bit rate can be dropped until a reliable connection can be maintained.

Alternatively, or additionally, a higher level of service can provide a computing device connected to the at least one access point with a faster response when compared to a computing device connected at lower levels of service. For example the high service level can provide a faster response than the low service level.

The method can preferentially be performed by polling computing devices connected to the network at a higher level of service, compared to a computing device connected to the network at a lower level of service.

In further alternative, or additional embodiments, a higher level of service can provide a computing device connected to the at least one access point with a lower latency compared to computing devices connected to the at least one access point at lower levels of service. For example, the high service level can provide a lower latency than the low service level.

In yet further alternative, or additional embodiments, a higher level of service can provide a computing device connected to the at least one access point with a more robust connection that is less likely to be terminated than computing devices connected to the access point at a lower level of service. For example, the high service level can provide a more robust connection than the low service level. Those of ordinary skill will appreciate that an access point can terminate its connection with a computing device. Such termination of the connection can occur for instance if (1) the access point becomes overloaded, (2) more high priority users wish to connect to the access point, resulting in low priority users having their connection terminated, or (3) for any other reason.

The method preferably provides different levels of service from an access point. In such an arrangement a computing device can be connected to the access point at any of the levels of service. Such an arrangement is convenient because a user of a computing device can connect to the network at any of the service levels offered from anywhere within the area covered by the network.

In an alternative, or additional, arrangement the method provides a plurality of access points, each providing a subset of the access levels. In the simplest arrangement, any one access point provides a single access level. For example one access point may provide the high service level, and a second access point may provide the low service level. Such an arrangement may be advantageous if it is desired to provide a predetermined access level for an area. For example the first class carriages of a vehicle, such as a train, may be provided with a high service level, whilst the standard class carriages may be provided with a low level of service.

The method can provide access points with directional antenna. An advantage of such a method is that it can provide predetermined areas with coverage from any access point. The method can provide predetermined areas having a predetermined service level.

Conveniently, the method uses a network comprising a plurality of channels. For example an 802.11 network provides three channels (A, B, C) evenly spread across the bandwidth available for the 802.11 network (for example between 2.4 GHz, and 2.4385 GHz for an 802.11b network). Generally, the channels are arranged such that the frequencies of the channels do not overlap, helping to ensure that there is no cross talk between the channels.

Further, the method may assign a service level to a channel of the network. For example, the high service level may be assigned to a first channel, and the low service may be assigned to a second channel. Such a method helps to ensure that there is no interference between data transmitted at different levels of service.

The method may provide transmission access points which are arranged to transmit data to computing devices. Further, the method may provide receiving access points which are arranged to receive data transmitted by computing devices. Generally, in network arrangements, a computing device will receive more data than it transmits (i.e. the downstream connection to the computing device is likely to require a higher bandwidth than the upstream connection from the computing device). Providing separate access points for reception and transmission of data is therefore advantageous because it allows less bandwidth to be provided for the receiving access points, since these are likely to be less heavily loaded. Providing less bandwidth in this manner is likely to make the method more cost effective; one of ordinary skill will appreciate that increased bandwidth generally means greater expense.

The method may comprise providing transmission access points on a different channel of the network from receiving access points. Such an arrangement is advantageous because it helps to ensure that there is no collision and subsequent loss of data.

In an alternative or additional method, transmission access points may be provided which utilise a network protocol different from the receiving access points. Again, such a method is advantageous because it helps to increase data integrity.

As an example, the transmission access points may be provided which rely on the 802.11b protocol, and the receiving access points may be provided that rely on the 802.11a protocol. One of ordinary skill will appreciate that this helps to avoid data collision, because the 802.11a protocol operates in the 5 Ghz frequency band, whereas the 802.11b protocol operates in the 2.4 Ghz band. The selection of protocols that operate in different frequency bands in this manner ensures that uplink and downlink data do not collide.

Alternatively, or additionally, access points may be provided which can transmit and receive data; i.e. combined transmission and receiving access points.

The method may be arranged to multicast data to computing devices. Such an arrangement is particularly convenient if more than one computing device is requesting the same data from the network. Therefore, the method may multicast data if more than one computing device requests the same data. Data which may be particularly appropriate to multicast would be video, or audio feeds, particularly if the feeds are of live data.

Conveniently, access-points poll computing devices with which they are in communication.

Conveniently, the method comprises providing each of the computing devices capable of communication with the network with software allowing a user to select the quality of service that he/she desires. Such a method is convenient because it provides convenient access to the network.

The method may allow a user to specify the level of service that he/she desires each time he/she logs on to the network, providing a flexible arrangement.

However, the method may include billing users according to the level of service to which they connect to the network. In such circumstances a user may only be permitted to connect to the network at a level of service for which they have credit or account privileges.

According to a second aspect of the invention there is provided a computer readable medium including instructions arranged to cause a computing device to perform the method of the first aspect of the invention.

According to a third aspect of the invention a computer system is arranged to allow at least one computing device to connect to the system using a wireless network connection to a wireless local area network. The system has at least one first access point capable of providing a higher level of service, and at least one second access point capable of providing a lower level of service compared to the first access point. Processing circuitry that controls the function of any access point connected to the system also controls the network such that the quality of service provided by the first and second access points meets predetermined criteria.

The access point capable of providing a higher level of service and the access point capable of providing a lower level of service may be provided by the same access point.

The system may comprise a plurality of access points, and such an arrangement is advantageous because it generally provides the network with a higher bandwidth with which to connect computing devices to the network.

Preferably, the network is arranged to transmit/receive data in a plurality of channels, which can be convenient because it can allow an area to be covered by the network with less problems of interference between cells of the network.

The system may be arranged such that a level of service is assigned a channel within the network.

Any one access point may be connected to computing devices using a single channel.

The system may comprise an 802.11 (or WIFI) network. Alternatively, or additionally, it may comprise a Bluetooth network, or any other suitable technology.

The system may comprise at least one transmission access point arranged to transmit data, and at least one receiving access point arranged to receive data. Such an arrangement is convenient because it is likely that the downlinks will be more heavily loaded with data than the uplinks, and therefore, it is advantageous to separate the uplinks (transmission access points) and the downlinks (receiving access points).

Further, the system may be arranged such that the receiving access points and the transmission access points are assigned different channels of the network. Such an arrangement ensures that data does not collide.

In an alternative or additional arrangement, the transmission and receiving access points operate using different network protocols. In one embodiment, the transmission access point may operate on the 802.11a or 802.11b and the receiving access points may operate on the other. Such an arrangement is convenient because it helps to increase the number of access points that the system can include. It will be appreciated that the 802.11b protocol has three distinct channels defined therein. Hence, the number of access points that can be assigned a separate channel is limited to three. By using a different protocol for the receiving access point, the number of access points that can, effectively, be assigned a separate channel is increased to four.

According to a fourth aspect of the invention there is provided a computer readable medium including instructions arranged to cause a computing device to function as a computer system according to the third aspect of the invention.

According to a fifth aspect of the invention there is provided a computing device programmed to communicate with the computer system of the third aspect of the invention.

According to a sixth aspect of the invention there is provided a computer program arranged to cause a computer system to cause a first access point, arranged to provide a wireless connection to a computing device, to provide a first level of service to a computing device connected thereto and a second access point, also arranged to provide a wireless connection to a computing device, to provide a second level of service, lower than the first.

According to a seventh aspect of the invention there is provided a computer system providing a wireless local area network, to which computing devices can be connected, the system having at least one transmission access point capable of transmitting data, at least one receiving access point capable of receiving data, and processing circuitry arranged to control operation of the transmission and receiving access points, wherein the transmission access point is arranged such that it operates on either a different channel of the same network, or uses a different network protocol compared to the receiving access point.

According to an eighth aspect of the invention there is provided a computer system arranged to allow at least one computing device to connect thereto using a wireless network connection to a wireless local area network. The system has at least one first access point capable of providing a higher level of service and at least one second access point capable of providing a lower level of service compared to the first access point. Processing circuitry controls the function of any access point connected to the system. The circuitry controls the network such that the quality of service provided by the first and second access points meets predetermined criteria. The first access point is arranged to cover a first area and the second access point is arranged to cover a second area such that there is minimal overlap of the first and second areas such that a computing device in the first area can connect to the first access point and a computing device in the second area can connect to the second access point.

The computer readable medium of any of the above aspects of the invention can be any one or more of the following: a floppy disk, a CDROM, a DVD ROM/RAM (including +R/RW and −R/RW), a super disk, any form of magneto optical disk, an internet download, a transmitted signal, a memory, a hard disk or the like.

### BRIEF DESCRIPTION OF THE DRAWINGS

There now follows by way of example only a detailed description of embodiments of the invention with reference to the accompanying drawings of which:

FIG. 1 is a block diagram of one arrangement of a network according to the present invention;

FIG. 2 a second arrangement of a network according to the present invention;

FIG. 3 is a frequency diagram for channels for the network arrangements shown in FIGS. 1 and 2;

FIG. 4 is a flow chart of a process running on a computing device connected to a network including the invention;

FIG. 5 is a flow chart of a process running on the network when a computing device attempts to connect to the network;

FIG. 6 is a block diagram of a server included in each of FIGS. 1 and 2;

FIG. 7 is a block diagram of a computing device included in each of FIGS. 1 and 2; and

FIG. 8 is a block diagram of a further example of a network provided by the present invention.

### DETAILED DESCRIPTION OF THE DRAWINGS

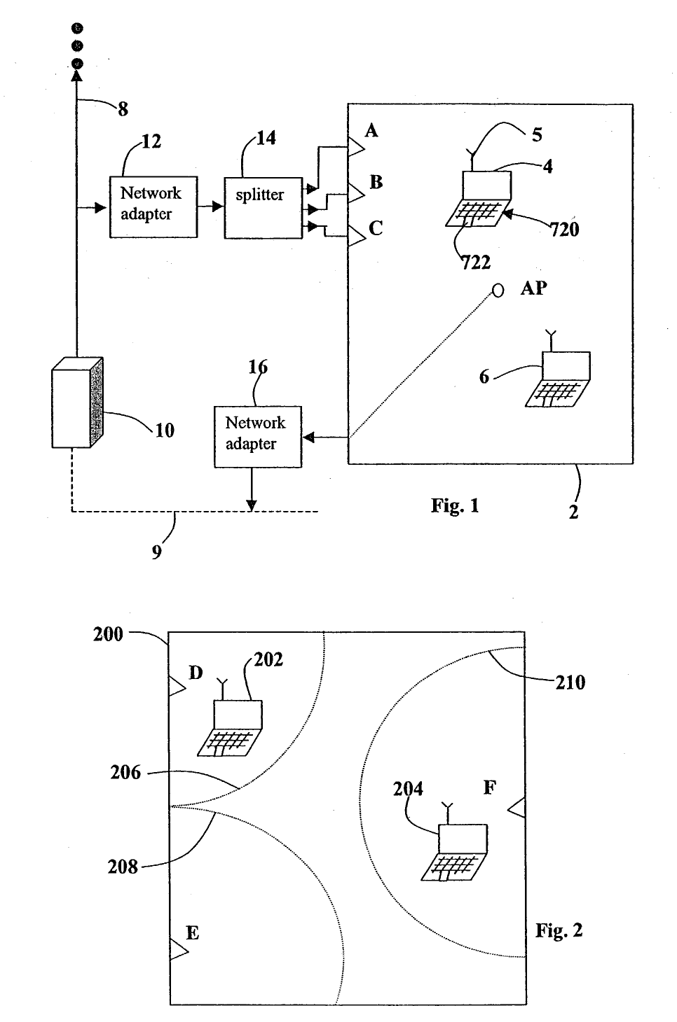

The network of FIG. 1 includes an area 2, which may be room, covered be a wireless network, in which one or more computing devices 4, 6 can be connected via wireless links to a network 8. In this embodiment the wireless network uses the WIFI (or IEEE 802.11) protocol. Those of ordinary skill fully understand this protocol, but they are directed to read the IEEE standard 802.11 for further information.

In FIG. 1, the network 8 is an Ethernet (which is defined by the IEEE standard 802.3, and those of ordinary skill are directed to read this standard if he/she requires further information). A server 10 stores data and facilitates communication over the network. The network can extend beyond area 2, and a plurality of further devices (not shown) may be connected thereto. The network is running under MICROSOFT™ NT 4.0 and the server 10 has an architecture commonly referred to as a pc architecture based around the INTEL™ X86 series of chips, and compatibles. In this case the server 10 has an INTEL PENTIUM III™ processor, or processing means, typically running at 900 MHz and accessing 1 Gb of memory, and 50 Gb of hard disk space. In alternative embodiments processors such as the AMD™ ATHLON™, POWERPC™ are equally possible.

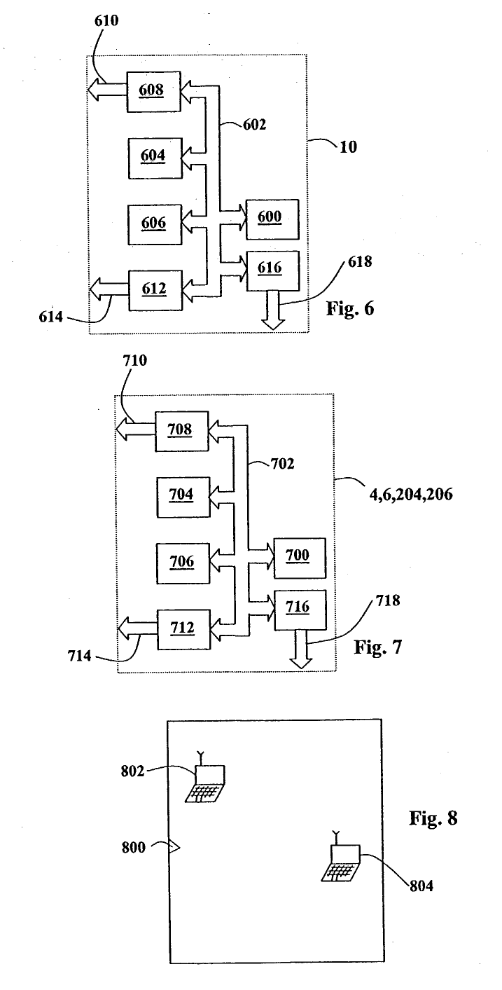

FIG. 6 is a block diagram of the architecture of the server 10. The processor 600, is connected, via a bus 602, to the memory (i.e. RAM) 604, and the hard drive 606. The bus 602 also connects the processor to a display driver 608, which can drive a monitor (not shown) connected to an output interface 610. An input/output controller 612 also connects to the bus 602 and allows a keyboard, mouse, etc. to be connected to the processor 600 via port 614. A network controller 616 connects the processor 600 to the network 8 via an output port 618. The server 10, together with the network adapters and splitters, provides the necessary processing circuitry to operate the network 8.

The area 2 has three transmission access points A, B, C and a receiving access point AP within it: point AP allows the computing devices 4, 6 within the area to connect to the server 10. The access points may be thought of as access means. A first network adapter 12 drives a splitter 14 that in turn drives three access points (A, B, C). The access point AP connects to the server 10 via a second network adapter 16 which connects to a second network 9. The second network 9 (and consequently, the receiving access point AP) use a different network protocol from the first network (and consequently the access points A, B, C), which ensures that no collision of data occurs between the transmission access points AP and the computing devices 4, 6 and the receiving access points and the computing devices 4, 6. For example the transmission access points A, B, C may rely on IEEE802.11b, whilst the receiving access point AP relies on IEEE802.11a. Indeed, it is possible to obtain integrated circuits that have the necessary circuits to provide access to both 802.11a and 802.11b networks and therefore, the computing devices 4, 6 can be fitted with network adapters capable of communicating with both 802.11a and 802.11b networks. A supplier of such an integrated circuit is Synad Technologies, of Reading, UK which manufactures the Mercury5G™ chipset. The access means may comprise any means for establishing a wireless connection although generally a radio link such, as WIFI access point, a BLUETOOTH™ transceiver, a HiperLAN access point, and the like, is used.

In the example shown the computing devices 4, 6 are portable (laptop) PC's running the LINUX operating system. However, in other embodiments the portable PC's may be any other form of computing device, and may be portable PC's running MICROSOFT™ WINDOWS™ 2000, APPLE™ iBOOKS™, PDA's, telephones, or any other form of computing device. Each of the computing devices 4, 6 has an antenna 5, allowing it to correspond with the access points, although the antenna need not be external to the computing device.

The structure of the computing devices 4, 6, 202, 204 is schematically shown in FIG. 7, and is similar to that of the server. The processor 700 is connected, via a bus 702, to the memory (i.e. RAM) 704, and the hard drive 706. The bus 702 also connects processor 700 to a display driver 708, which can drive a monitor (not shown) connected to an output interface 710. An input/output controller 712, is connected to the bus 702 and responds to a keyboard 720, and a trackpad 722 via connections 714 to provide a user input to the computer device. A network wireless network PCMIA (Personal Computer Manufacturer Interface Adapter) card 716 connects the processor 700 to the network 8 via an antenna 718.

In use, the access points A, B, C provide down-links (i.e. provide data from the network) to computing devices 4, 6 within the area 2. The access point AP provides an up-link (i.e. provide data to the network) from each of the computing devices 4, 6 within the area 2.

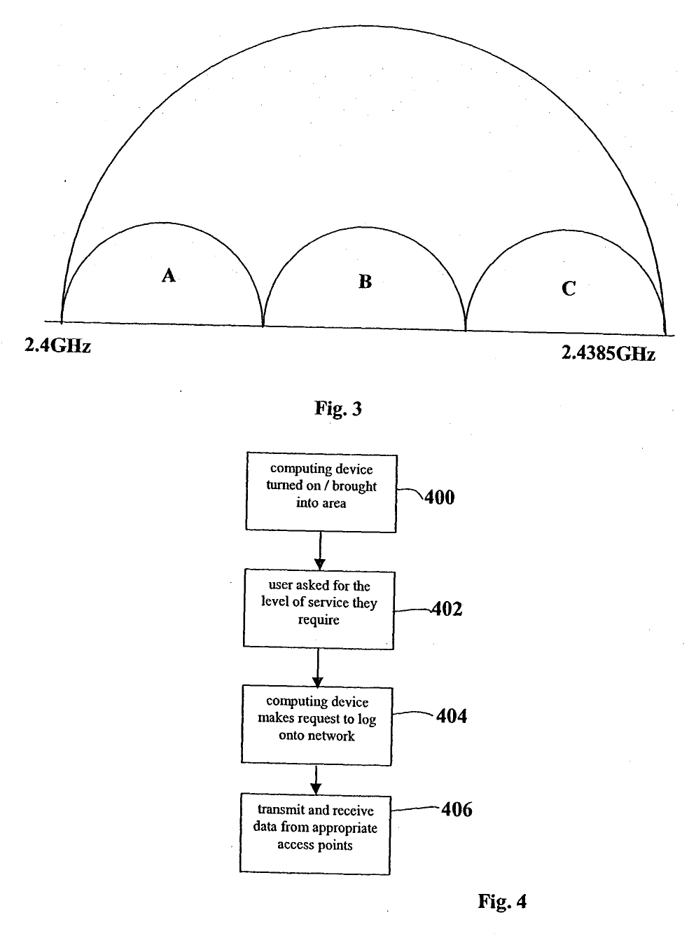

Each of the access points A, B, C provides a different level of service to computing devices 4, 6 within the area 2. The access point A provides a high service level, access point B a medium service level, and the access point C a low service level. Those of ordinary skill will appreciate that a WIFI network has bandwidth of 0.0385 GHz between 2.4 GHz and 2.4385 GHz available for its use, which comprises three channels (in this case the channels are referred to as channels A, B, C). Each of the three channels occupies a third of the overall bandwidth available (i.e. roughly 0.01283 GHz), which helps to ensure that there is no cross talk, or other interference between the channels A, B, C. This arrangement of the channels within the available bandwidth is shown in FIG. 3.

(In another embodiment it would be possible to reduce the number of transmission access points to two (A and B), and one receiving access point AP, and assign a separate channel to each of the transmission access points and the receiving access point. For example channels A and B could be assigned to the transmission access points A and B and channel C could be assigned to the receiving access point C).

In the arrangement shown in FIG. 1 channel A is fed to access point A, channel B is fed to access point B, and channel C is fed to access point C. Therefore, if a user of a computing device has requested a high service level he/she generally receives data on channel A, if the user requested a medium service level he/she generally receives data on channel B, and if the user requested a low service level he/she generally receives data on channel C. Any data that a computing device 4, 6 within the area 2 sends to the network is sent via access point AP, using the 802.11a protocol, which operates in the 5 GHz frequency range.

The first network adapter 12 is configured so that it services requests for data on channel A above requests for data on channel B, which in turn are prioritised above requests for data on channel C. Therefore, if a computing device 4, 6 requests data on high priority channel A, this request is put ahead of requests on the medium and low service channels B and C. Thus, users of computing devices that have requested a high level of service receive a higher level than users that have only requested a medium, or a low level of service.

To facilitate the functionality described above, computing devices 4, 6 wishing to make use of the levels of service provided in the area 2 have driver software loaded thereon. The driver software allows a user to specify the level of service that he/she requires. When the computing device 4, 6 is turned on within the area 2 or brought into the network, then the user is prompted to input the level of service (high/medium/low) that he/she requires. The server 10 checks that user's/computing device's account privileges and if these privileges are sufficient the requested level of service is granted. In this embodiment, if the user does not have the required driver software he/she can log onto the network, but can only receive a low level of service (i.e. use channel C).

Data sent to the computing devices 4, 6 within area 2 are, in this embodiment, charged on a data volume basis (i.e. there is a fixed charge per megabyte (MB) sent from the access point to the computing device 4, 6). The charge data volume is higher on the high service level, compared to the medium service level, which in turn is higher than the low service level.

As with any network, a user/computing device 4, 6 must have an account on the network for them to use the facilities offered. In this embodiment charges made for data sent from the access point are charged to the user's/computing device's 4, 6 account. The privileges that server 10 checks when a user logs onto the network include whether that user/computing device 4, 6 has enough credit available in the relevant account to enable the desired connection.

In this embodiment the high service level has specified a maximum latency period for which users have to wait before the computing device that he/she is using is polled by the access point A. As the number of computing devices 4, 6 using the high service level increases within the area 2 then it becomes harder for a user to remain inside the maximum specified latency. Therefore, if the number of users requesting a high service level increases beyond that allowing the maximum latency to be met, one of the other two channels (C, B) is used in order to allow the required quality of service to be maintained. The computing device 4, 6 that is switched to the different channel is informed by the access point that it should switch the frequency that it is using and further communications occur on the newly specified channel. Generally, the C channel is used in preference to the B channel because such operation removes service from users requesting a low quality of service rather than removing service from users that have requested a medium level of service. Such use of one of the other channels B, C may result in users of that channel losing his/her network connection in order to maintain the high level of service to the users that have requested this level of service. (If users specifying the high service level leave the area 2, server 10 switches computing devices 4, 6 that have been switched to a channel other than channel A back to the A channel; the access point (B, or C) with which the computing device is communicating informs the computing device 4, 6 that future communications will be performed on the A channel, and that therefore, the computing device should switch to an appropriate frequency).

If a plurality of users wish to receive the same stream of data (for example if a plurality of users wish to view the same video stream of a live event, etc.) then the data can be multicast to them. Such multicasting helps to prevent a performance drop off as the number of users within any one service level increases, as discussed in the previous paragraph. In such an arrangement each of the computing devices 4, 6 to which data is to be multicast is given a predetermined IP address which the computing devices must address in order to receive the multicast data from the network. One of the three channels A, B, C is then used to transmit data from the relevant IP address.

In the arrangement shown in FIG. 2 an area 200 is again covered by a wireless network according to the WIFI protocol (in this example 802.11b). Coverage is provided by three access points D, E, F, which in this embodiment provide both the up and down links to computing devices 202, 204 within the area 202. The access points of FIG. 2 are connected to a network much in the same way as the access points A, B, C as shown in FIG. 1, but for the sake of clarity this information has been omitted from FIG. 2. In this embodiment the access points D, E, F are directional in nature and therefore, each has an area 206, 208, 210 surrounding it with which it can communicate. The areas 206, 208, 210 are arranged such that there is minimal overlap between them. It will be appreciated that ideally there is no overlap, but with the nature of radio signals used to generate the Wireless Network there may in reality be an overlap of the areas covered by the access points D,E,F.

Again one of the channels of the WIFI network is assigned to each one of the access points. In this embodiment channel A is assigned to access point D, channel B is assigned to access point E, and channel C is assigned to access point E. As with the embodiment of FIG. 1, the high service level is served by channel A (and therefore, access point D), the medium service level is served by channel B (and therefore, access point E), and the low service level is served by channel C (and therefore, access point F). As can be seen from FIG. 2, no receiving access point AP has been provided and therefore the access points D,E,F both send and receive data. In other embodiments a receiving access point can be provided which includes a dedicated channel within the network of the transmission access points, or can be operated using a different network protocol (for example 802.11a).

As with the first embodiment, computing devices 202, 204 wishing to use the network have driver software loaded on to them that allows them access to the network. Again, higher charges are levied for data delivered from the access point D providing a higher level of service than for the access point E that delivers a medium level of service, which in turn has higher charges levied than for data delivered from the access point F that delivers a low level of service. In this embodiment a user does not specify that it wishes to have data delivered to it at a particular level of service, but the user positions his/her computing device so that it communicates with the correct access point D, E, F. Because each of the access points is communicating on a different WIFI channel (A, B, C) there should be no cross talk or other interference. Therefore each of the access points can substantially serve the complete area or room, etc.

Therefore, should a user wish to receive data at the high service level he/she stands in the area served by the access point D. If the user wishes to receive data at the medium service level, he/she stands in the area served by the access point E. If the user wishes to receive data at the low service level, he/she stands in the area served by the access point F. Such an arrangement can be conveniently applied to situations such as railway carriages, in which access point D is provided in first class carriages, access point E is provided in standard class carriages, and access point F is provided in economy class carriages.

FIG. 8 is a block diagram of an area in which a single access point 800 provides both the higher and lower levels of service. Computing devices 802, 804 in communication range of access point 800 can connect to the network using the higher or lower level of service. The single access point 800 may comprise access points using different channels of the same network protocol, or using different protocols located in a single housing.

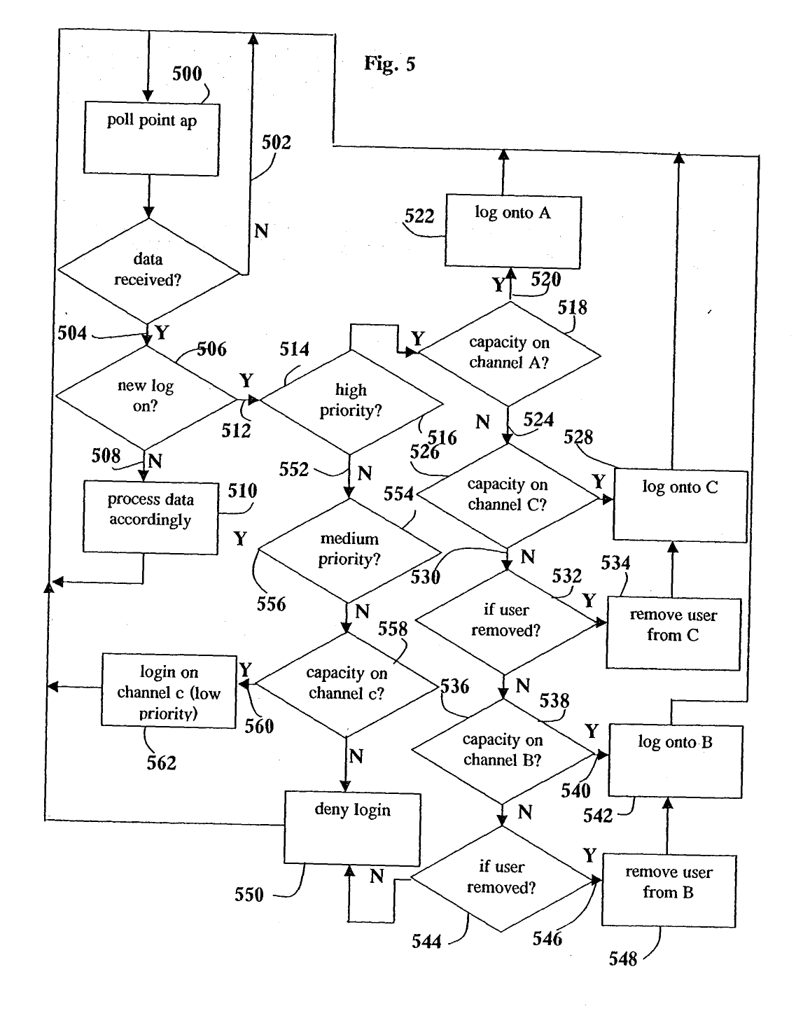

FIG. 4 is a flow diagram of the process (i.e. program) that hard drive 706 of computing device 4, 6 stores and causes the computing device to run when computing device 4, 6 is turned on (operation 400) or brought into the area 2 covered by the network. Firstly, the computing device asks the user of the computing device 4, 6 at what service level he/she would like to connect to the network(operation 402). Once the computing device has ascertained the desired level, computing device 4, 6 makes a request to the user to logon to the network (operation 404) (the processes running on the network for this stage are outlined in FIG. 5). If a network connection is granted, the programs enables the computing device to start to send and receive data (operation 406).

The processes running on the network 8 and stored in hard drive 606 of server 10 to service a request to log onto the network are outlined with the aid of FIG. 5. This diagram is specifically discussed in relation to the arrangement shown in FIG. 1. The network polls the access point AP (operation 500). If no data has been received by the access point AP, the process loops and checks again if any data has been received (operation 502).

If data has been received (operation 504), then processor 600 of server 10 ascertains whether the data is a request from a new computing device 4, 6 to log onto the network (operation 506). If it is not a request for a new logon (operation 508), the data is processed accordingly (operation 510) and the process again polls the access point AP for further data (operation 500).

If the received data were a request for a new logon (operation 512), then processor 600 of server 10 determines whether the request was for a connection at high priority (operation 514). If the request was for a high priority connection (operation 516) then processor 600 determines whether there is enough capacity on channel A (operation 518). If there is enough capacity on channel A (operation 520) then the computing device 4, 6 is logged onto the network (operation 522), and the network continues to poll the access point AP (operation 500).

If there was not enough capacity on channel A (operation) 524 then processor 600 determines (operation 526) whether there is spare capacity on channel C to give a computing device a high service connection using channel C. If there is spare capacity then the computing device 4, 6 is logged onto the network using channel C (operation 528) and the network thereafter continues to poll the access point AP (operation 500).

If there is not enough spare capacity on channel C to offer a high service level connection (operation 530), then processor 600 determines whether there would be enough capacity to give a high service level connection on channel C if a user having a low service level connection were removed from the channel C (operation 532). If there would be enough capacity with a low level user removed then server 10 removes a low service level user from channel C (operation 534), and the server logs the new high service level user onto channel C (operation 528) and the network again starts to poll the access point AP (operation 500).

If there is not enough capacity even with a user removed from channel C (operation 536) then server 10 assesses whether there is enough capacity on channel B to provide a user with a high level of service operation 538). If there is enough capacity (operation 540) then server 10 logs the user onto the network (operation 542) on channel B and the network continues to poll the access point AP (operation 500).

If there is not enough capacity then server 10 assesses whether users having a low or medium level of service can be removed from channel B (operation 544). If such users can be removed (operation 548) then server 10 removes the user having a low level of service in preference (operation 548). Server 10 then logs the new user having a high service level on channel B (operation 542), and the network continues to poll the access point AP (operation 500).

If there is not enough capacity on channel B even with a user removed, then server 10 denies logon of the new user (operation 550). In this case because the log on request has been made for a high level of service, then a denial of logon means that all three channels are at capacity with users having a high level of service.

If the request for a logon was not for a high level of service (operation 552), then server 10 assesses whether or not the request was for a medium level of service (operation 554). If it is, server 10 makes similar assessments as for the high level of service, as described above. If there is no capacity on the default B channel, then server 10 assesses the other channels A, B, and determines if users having a low level of service can be removed from the network. If server 10 denies a logon (operation 550) the network is already at capacity with users having a high or medium level of service.

If the network logon request were for a low level of service connection, server 10 assesses whether there is capacity on channel C for such a connection (operation 558). If server 10 determines the network has adequate capacity (operation 560) the server logs on the user (operation 562), and the network server 10 continues to poll the access point AP (operation 500). If there is no capacity on channel C, server 10 denies the user a logon (operation 550); this operation implies that the network is already at capacity with users having medium, high, and low level of service connections.

One of ordinary skill will appreciate that there are many different specifications within the 802.11 family of protocols. It may be possible to utilise any of the 802.11 protocols to realise this invention and the 802.11a, and 802.11b have been used as convenient examples.

What is claimed is:

1. A method of controlling the quality of service of a wireless local area network to a computing device, the network including at least a first and a second access point each arranged to allow the computing device to be connected to the wireless network, the method comprising:
providing at least a high and a low service level so that computing devices connected to the network at the high service level receive a higher level of service from the network than computing devices connected to the network at the low service level, and activating the first access point so it generally provides the high level of service and the second access point so it generally provides the low level of service.

2. A method according to claim 1 comprising providing a number of service levels in between the high level of service and the low level of service.

3. A method according to claim 1 comprising providing a service level with a dedicated channel of a wireless network.

4. A method according to claim 1 comprising operating the first and second access points with different network protocols.

5. A method according to claim 1 comprising arranging at least one of the first and second access points to act as a transmission access point providing a substantially one way data connection which transmits data to computing devices having a wireless connection thereto.

6. A method according to claim 5 comprising utilising a separate channel of said network protocol for the at least one transmission access point.

7. A method according to claim 5 comprising utilising a different network protocol for the at least one transmission access point compared to at least one of the first and second access points.

8. A method according to claim 1 wherein the network includes at least one receiving access point, in addition to the first and second access points, and further including providing a substantially one way data connection to receive data from computing devices having a wireless connection thereto.

9. A method according to claim 8 comprising utilising a separate channel of the network protocol for the at least one receiving access point.

10. A method according to any of claims 8 comprising utilising a different network protocol for the at least one receiving access point compared to at least one of the first and second access points.

11. A method according to claim 1 comprising providing at least one further access point in addition to the first and second access points, each further access point providing a subset of the service levels.

12. A method according to claim 1 comprising providing access points with directional antenna.

13. A method according to claim 1 comprising providing predetermined areas capable of having a wireless network connection made to a computing device therein with a network connection having a predetermined service level.

14. A method according to claim 1 comprising multicasting data to computing devices.

15. A method according to claim 1 comprising providing computing devices capable of communication with the network with software allowing a user to select the quality of service that he/she desires.

16. A method according to claim 15 comprising allowing a user to specify the level of service that he/she desires each time he/she logs onto the network.

17. A method according to claim 1 comprising billing users according to the level of service to which they connect to the network.

18. A computer readable medium including instructions arranged to cause a computing device to perform the method of claim 1.

19. A computer system arranged to allow at least one computing device to connect thereto via a wireless network connection to a wireless local area network, the system comprising at least one first access point capable of providing a first level of service, and at least one second access point capable of providing a second, lower level of service compared to the first access point, and processing circuitry arranged to control the function of any access point connected to the system, wherein the circuitry is arranged to control the network such that the quality of service provided by the first access point is higher than that of provided by the second access point.

20. A system according to claim 19 which is arranged to transmit data using a network having a plurality of channels.

21. A system according to claim 20 which is arranged such that a level of service is assigned a channel within the network.

22. A system according to claim 19 in which at least one of the first and second access points is included in a transmission access point arranged to provide a substantially one way data connection to transmit data to a computing device having a wireless connection thereto.

23. A system according to claim 22 in which a separate channel of the wireless network is arranged to be the transmission access point.

24. A system according to claim 22 in which a different network protocol is arranged to be used for the transmission access point compared to at least one of the first and second access points.

25. A system according to claim 19 in which the system comprises at least one receiving access point arranged to provide a substantially one way data connection to receive data from a computing device having a wireless connection thereto.

26. A system according to claim 25 further including a separate channel of the wireless network for the receiving access point.

27. A system according to claim 25 in which a different network protocol is arranged to be used for the receiving access point compared to at least one of the first and second access points.

28. A system according to claim 19 in which at least one access point is arranged to use the IEEE802.11a protocol.

29. A system according to claim 19 in which at least one of the access points is arranged to use the IEEE802.11b protocol.

30. A system according to claim 19 in which the first access point is arranged to cover a first area and the second access point is arranged to cover a second area such that there is minimal overlap of the first and second areas such that a computing device in the first area can connect to the first access point and a computing device in the second area can connect to the second access point.

31. A computer readable medium including instructions arranged to cause a computing device to function as a computer system according to claim 19.

32. A computing device programmed to communicate with the computer system of claim 19.

33. A computer program arranged to cause a computer system to cause a first access point, arranged to provide a wireless connection to a computing device, to provide a first level of service to a computing device connected thereto and a second access, also arranged to provide a wireless connection to a computing device, to provide a second level of service, lower than the first.

34. A computer system for supplying a wireless local area network to which computing devices can be connected, the system comprising at least one transmission access point arranged to provide a substantially one way data connection to transmit data, at least one receiving access point arranged to provide a substantially one way data connection to receive data, and processing circuitry arranged to control operation of the transmission and receiving access points, wherein the transmission access point is arranged such that it operates on either a different channel of the same network, or uses a different network protocol compared to the receiving access point.

35. A system according to claim 34 wherein the transmission access point is arranged to operate using one of the IEEE802.11a and IEEE802.11b protocols and the receiving access point is arranged to use another of the protocols, not used by the transmission access point.

36. A system according to claim 34 which is arranged to transmit data using a network having a plurality of channels.

37. A system according to claim 36 which is arranged such that a level of service is assigned a channel within the network.

38. A system according to claim 34 in which a separate channel of the wireless network is arranged to be used for the transmission access point.

39. A system according to claim 34 in which a different network protocol is arranged to be used for the transmission access point and the receiving access point.

40. A system according to claim 34 in which a separate channel of the wireless network is arranged to be used for the receiving access point.

41. A system according to claim 34 in which a different network protocol is arranged to be used for the receiving access point compared to the transmission access point.

42. A system according to claim 34 in which a plurality of transmission access points are provided.

43. A system according to claim 42 in which each transmission access point is arranged to cover an area such that there is minimal overlap between areas covered by each of the transmission access points.

44. A computer system arranged to allow at least one computing device to connect thereto using a wireless network connection to a wireless local area network, the system comprising at least one first access point capable of providing a first level of service, and at least one second access point capable of providing a second, lower level of service compared to the first access point, wherein the first access point is arranged to cover a first area and the second access point is arranged to cover a second area such that there is minimal overlap of the first and second area such that a computing device in the first area can connect to the first access point and a computing device in the second area can connect to the second access point.

45. A system according to claim 44 which is arranged to transmit data using a network having a plurality of channels.

46. A system according to claim 45 which is arranged such that a channel within the network has an assigned level of service.

47. A system according to claim 44 in which the system comprises at least one transmission access point arranged to provide a substantially one way data connection to transmit data to a computing device having a wireless connection thereto.

48. A system according to claim 47 in which at least one of the first and second access points is included in the transmission access point.

49. A system according to claim 48 in which a separate channel of the wireless network is arranged to be used for the transmission access point.

50. A system according to claim 47 in which a different network protocol is arranged to be used for the transmission access point compared to at least one of the first and second access points.

51. A system according to claim 44 in which the system comprises at least one receiving access point arranged to provide a substantially one way data connection to receive data from a computing device having a wireless connection thereto.

52. A system according to claim 51 further including a separate channel of the wireless network for the receiving access point.

53. A system according to claim 51 in which a different network protocol is arranged to be used for the receiving access point compared to at least one of the first and second access points.

54. A system according to claim 44 in which at least one of the access points is arranged to use the IEEE802.11a protocol.

55. A system according to claim 44 in which at least one of the access points is arranged to use the IEEE802.11b protocol.

56. A computer system arranged to allow at least one computing device to connect thereto using a wireless network connection to a wireless local area network, the system comprising at least one first access means for providing a wireless connection and arranged to provide a first level of service, and at least one second access means for providing a wireless connection and arranged to provide a second, lower level of service compared to the first access means, and processing means arranged to control the function of any access means connected to the system, wherein the processing means is arranged to control the network such that the quality of service provided by the first access means is higher than that provided by the second access means.

57. A computer system for providing a wireless local area network to which computing devices can be connected, the system comprising at least one transmission access means for providing a wireless connection and arranged to provide a substantially one way data connection to transmit data, at least one receiving access means for providing a wireless connection and arranged to provide a substantially one way data connection to receive data, and processing circuitry arranged to control operation of the transmission and receiving access points, wherein the transmission access means is arranged such that it can operate on either a different channel of the same network, or can use a different network protocol compared to the receiving access means.
